(19) United States
(12) Patent Application Publication
(10) Pub. No.: US 2014/0258358 A1
(43) Pub. Date: Sep. 11, 2014

(54) METHOD OF COMBINING NETWORK DATA AND MOBILE DEVICE USING THE SAME

(71) Applicant: HTC CORPORATION, Taoyuan County (TW)

(72) Inventors: Zih-Ci Lin, Taoyuan County (TW); Ruey-Jer Chang, Taoyuan County (TW); Wei-Chung Yang, Taoyuan County (TW)

(73) Assignee: HTC CORPORATION, Taoyuan County (TW)

(21) Appl. No.: 13/792,227

(22) Filed: Mar. 11, 2013

(51) Int. Cl. H04L 29/08

(52) U.S. Cl. CPC H04L 67/104
USPC 709/201

(57) ABSTRACT

A method for combining network data for a mobile device includes connecting to a plurality of networks; receiving a plurality of data from the plurality of networks; obtaining a plurality of parameters from each of the plurality of data; comparing the plurality of parameters of each of the plurality of data, to obtain a plurality of similar data; combining the plurality of similar data into at least one combined data; and displaying the at least one combined data.

### BACKGROUND OF THE INVENTION

1. Field of the Invention

The present invention relates to a method for combining network data and a mobile device using the same, and more specifically, to a method for combining network data according to various parameters, so as to facilitate viewing and replying to network data, and a mobile device using the same.

2. Description of the Prior Art

With the growing popularity of various social networks (e.g. Facebook, Twitter, etc.), it is now common for a user to have many social network accounts. Thus, users may often post or share a same piece of information on these different accounts, respectively. Thus, data redundancy becomes a problem, as another person who subscribes to the user's social status may receive redundant or identical messages originating from different social network accounts of the user. This may cause information overload by requiring users to sift through and process a lot of redundant social network data, which is also very time-consuming. Also, it is also hard to reply to all these messages originating from different social network websites.

Therefore, it is necessary to develop a way for combining or aggregating similar social network data into a more concise and condensed form, so as to facilitate social data viewing and replying.

### SUMMARY OF THE INVENTION

It is therefore an objective of the present invention to provide a method for combining network data so as to allow a user to effectively process and reply to network data.

The present invention discloses a method of combining network data for a mobile device, comprising connecting to a plurality of networks; receiving a plurality of data from the plurality of networks; obtaining a plurality of parameters from each of the plurality of data; comparing the plurality of parameters of each of the plurality of data, to obtain a plurality of similar data; combining the plurality of similar data into at least one combined message; and displaying the at least one combined message.

The present invention further discloses a method of replying to network data for a mobile device, comprising obtaining a combined message corresponding to a plurality of similar data from a plurality of networks; obtaining a reply message corresponding to the combined message from a user; and replying to at least one of the plurality of similar data with the reply message.

The present invention further discloses a mobile device for combining network data, comprising a communication interfacing unit, for connecting to a plurality of networks; a processing means; and a storage unit, for storing a program code to indicate the processing means to perform the following steps: receive a plurality of data from the plurality of networks; obtain a plurality of parameters from each of the plurality of data; compare the plurality of parameters of each of the plurality of data, to obtain a plurality of similar data; combine the plurality of similar data into at least one combined message; and display the at least one combined message.

The present invention further discloses a mobile device for replying to network data, comprising a communication interfacing unit, for connecting to a plurality of networks; a processing means; and a storage unit, for storing a program code to indicate the processing means to perform the following steps: obtain a combined message corresponding to a plurality of similar data from the plurality of networks; obtain a reply message corresponding to the combined message from a user; and reply to at least one of the plurality of similar data with the reply message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an example of the present invention.

FIG. 2 is a schematic diagram of a process according to an example of the present invention.

FIG. 3A and 3B are schematic diagrams of operations of a user viewing and replying to network data according to the processes shown in FIGS. 1 and 2, respectively.

FIG. 4 is a schematic diagram of a mobile device according to an example of the present invention.

### DETAILED DESCRIPTION

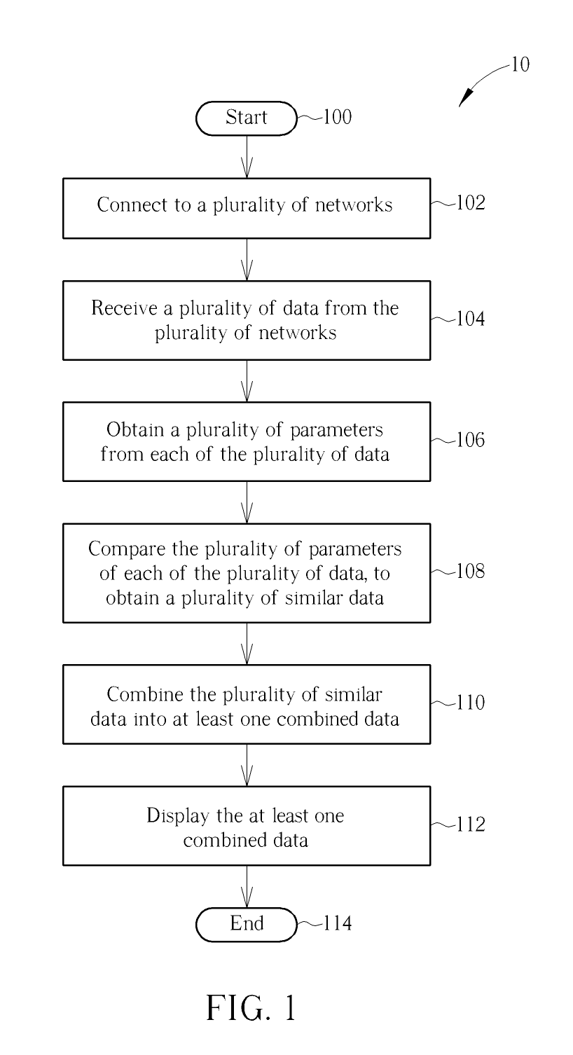

Please refer to FIG. 1, which is a schematic diagram of a process 10 according to an example of the present invention. The process 10 is a method for combining network data for a mobile device. The network data maybe text/video/audio messages, photos, images, or icons, and is not limited herein. The process 10 includes the following steps:

Step 100: Start.

Step 102: Connect to a plurality of networks.

Step 104: Receive a plurality of data from the plurality of networks.

Step 106: Obtain a plurality of parameters from each of the plurality of data.

Step 108: Compare the plurality of parameters of each of the plurality of data, to obtain a plurality of similar data.

Step 110: Combine the plurality of similar data into at least one combined data.

Step 112: Display the at least one combined data.

Step 114: End.

According to the process 10, the user can use the mobile device to access a plurality of data fed from various networks, such as public network, private network and social network. The data are first compared to see if any of them are similar according to a plurality of parameters obtained from each of the plurality of data. If so, a plurality of similar data are obtained and may be condensed into at least one combined data. The user is only presented with the combined data, and this significantly reduces the amount of information load that the user has to process. In the prior art, no such comparing or combining is performed, and the user may be faced with information overload by having to process a lot of redundant network data, which is also very time-consuming. In comparison, according to the process 10, the mobile device smartly identifies similar network data from the user's friend feeds, and only presents to the user the combined data, which is much more concise and condensed.

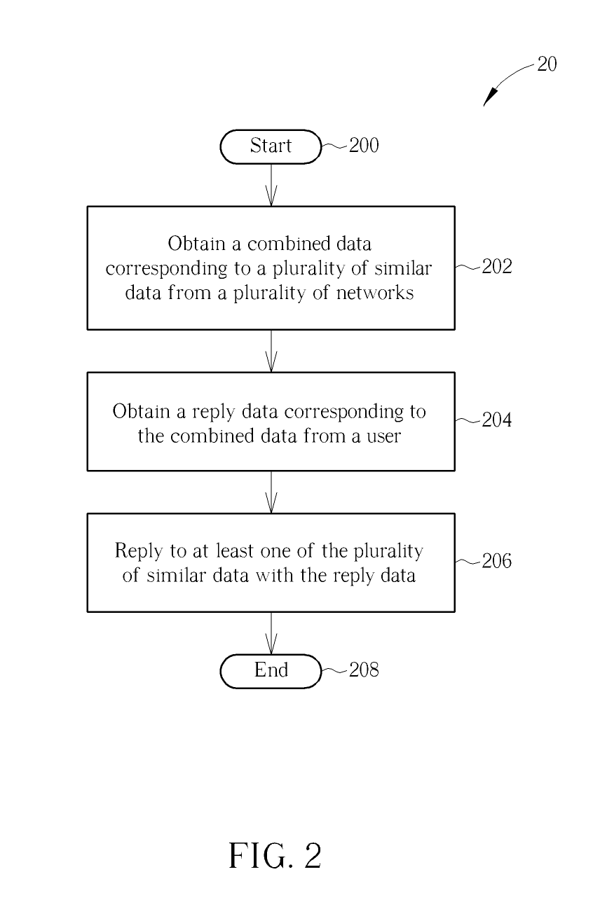

After the user views the combined data, he/she may choose to reply to the data. Since the combined data may possibly be composed of data sourced from different networking sites, the user should be able to choose to reply to some or all of the source networks. Accordingly, please refer to FIG. 2, which is a schematic diagram of a process 20 according to an example of the present invention. The process 20 is a method for replying to network data, and includes the following steps:

Step 200: Start.

Step 202: Obtain a combined data corresponding to a plurality of similar data from a plurality of networks.

Step 204: Obtain a reply data corresponding to the combined data from a user.

Step 206: Reply to at least one of the plurality of similar data with the reply data.

Step 208: End.

According to the process 20, after the user has viewed the combined data, the user may choose to reply to some or all of the source data within the similar data, which may have originated from different sites within the networks. The user is prompted to input a reply data, and maybe provided with the option of replying to some or all of the source data. In the prior art, similar network data are scattered and not combined, and thus the user cannot choose to reply to the data together, but instead has to reply to each data separately. The user is thus faced with a repetitive time-consuming task which can be automated. In comparison, according to the process 20, the user can input the reply once, and the mobile device smartly posts the reply data to some or all of the source data from various sites, according to the user's choosing.

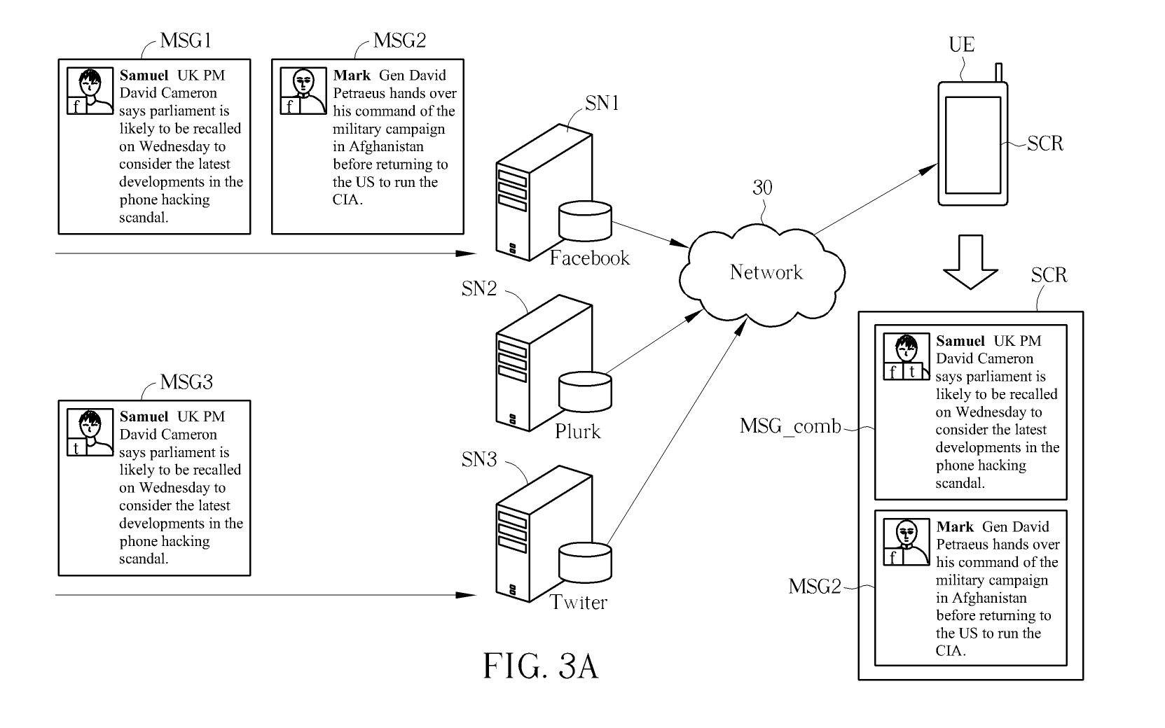

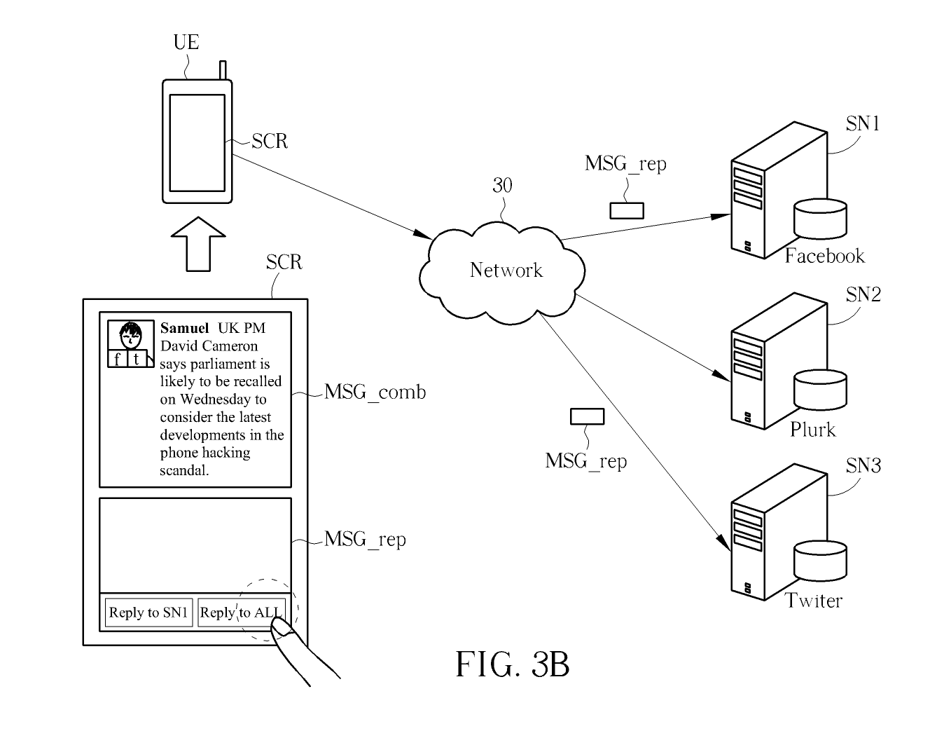

In more detail, please refer to FIG. 3A and 3B, which are schematic diagrams of operations of viewing and replying to network data according to the processes 10 and 20 shown in FIGS. 1 and 2. As shown in FIG. 3A, a mobile device UE connects to and receives network data from networks SN1, SN2, and SN3 (e.g. Facebook, Plurk, and Twitter, respectively) via a network 30. In this example, the network data are text messages for simplicity. Therefore, the mobile device UE receives messages MSG1-MSG3 from the networks SN1-SN3, wherein the messages MSG1 and MSG2 originate from the network SN1, and the message MSG3 originates from the network SN3. Next, there may be three parameters P1, P2, and P3 obtained from each of the messages MSG1-MSG3. For a specific message, the parameter P1 may be the author of the message; the parameter P2 may be the content body of the message; and the parameter P3 may be the date and time which the message was posted or generated. According to the process 10, the parameters P1-P3 of the messages MSG1-MSG3 are compared for similarity. In FIG. 3A, the messages MSG1 and MSG3 have similar content and are posted by a same author onto different networks SN1 and SN3, respectively. In other words, the author “Samuel” shared the same message on his Facebook and Twitter account, most probably at the same time. Therefore, since the messages MSG1 and MSG3 are posted by the same user, they would have identical values for the parameter P1. Since the messages MSG1 and MSG3 are posted around the same time, their parameters P3 would also have similar values (e.g. within a time range of ten minutes). Also, the parameter P2 would also be similar, if not identical, since the message contains the same information. For instance, common keywords may be found in the messages MSG1 and MSG3 (e.g. “David Cameron”, “Parliament”, or “phone hacking”). On the other hand, the message MSG2 was posted by a totally different author (the parameter P1 has value “Mark”) on the network SN1, probably at a completely different time point. Therefore, after comparing the messages MSG1-MSG3, the mobile device UE would determine that the messages MSG1 and MSG3 are similar messages, and combine the similar messages MSG1 and MSG3 into a combined message MSG_comb according to the process 10. Finally, the user is presented with the combined message MSG_comb and the separate message MSG_2. As such, redundant data is combined and the user is faced with a lower information load, and thus enabled to process his/her network friend feed more efficiently.

Next, please continue to refer to FIG. 3B, which shows the user replying to network data on the mobile device UE according to the process 20. As shown in FIG. 3B, the user selects the combined message MSG_comb and, after reading the message, wishes to reply to the combined message MSG_comb. The combined message MSG_comb corresponds to the MSG1 and MSG3 previously received from the networks SN1 and SN3, respectively. The user inputs a reply message MSG_rep, and is presented with the option to reply to only one or all of the source networks SN1 and SN3. For example, the user may select to reply to all of the sources, so the MSG_rep is accordingly transmitted to the corresponding networks SN1 and SN3 via the network 30.

In FIG. 3A and FIG. 3B, “f” or “t” included in messages MSG1, MSG2, MSG3 and the combined message MSG_comb represent which site the corresponding message is originated from. For example, the messages MSG1 and MSG2 are originated from the network SN1, i.e. Facebook; thus, the messages MSG1 and MSG2 are marked with “f”. However, the “f” and “t” marks are used to illustrate the example shown in FIG. 3A and FIG. 3B, and may not be shown in practical, or may be replaced by different notations.

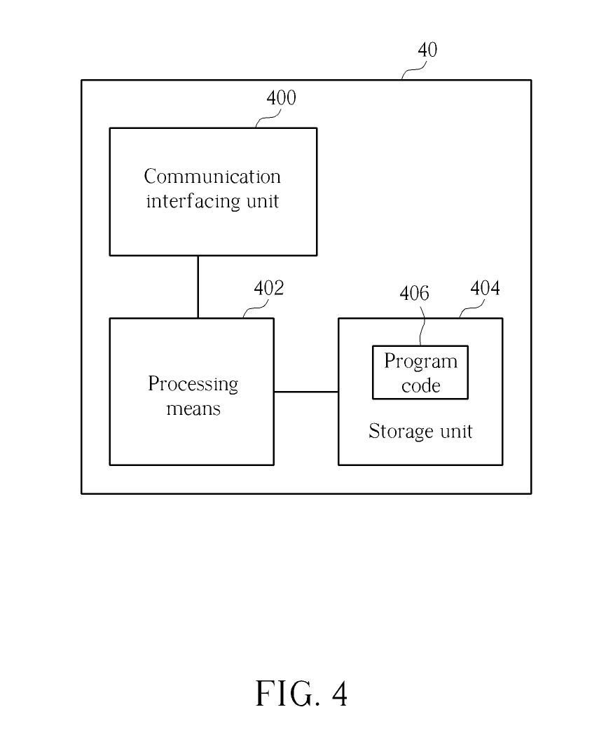

In addition, each step of the processes 10 and 20 may be compiled into corresponding program code to implement the processes 10 and 20 in a mobile device. Please refer to FIG. 4, which is a schematic diagram of a mobile device 40 according to an example of the present invention. The mobile device 40 includes a communication interfacing unit 400, a processing means 402, a storage unit 404, and a program code 406. The program code 406 is stored in the storage unit 404, and can be used for implementing the process 10 and 20 by indicating the processing means 402 to perform operations corresponding to the processes 10, 20 according to network data received by the communication interfacing unit 400. Implementing the process 10, 20 through the program code 406 should be well-known to those skilled in the art, and is not detailed here. Notably, the processing means 402 and the storage unit 404 of the mobile device 40 may be implemented via hardware, software, or firmware, etc., though not limited thereto. The mobile device 40 maybe any electronic product such as mobile phone, tablet, personal digital assistant (PDA), etc.

Note that in the context of this disclosure, a machine readable storage medium or a non-transitory computer-readable medium stores programs for use by or in connection with a data processing system, apparatus, or device. In this regard, one example, among others, is a machine readable storage medium embodying a program executable in a data processing system such as the mobile device 40 in FIG. 4. In accordance with such examples, the program may be executed cause the data processing system to perform the process 10 and/or 20.

Notably, a spirit of the present invention is to facilitate network data viewing or replying by combining similar data according to different parameters. Suitable modifications or variations may be made by those skilled in the art, and are not limited to the embodiments above. For example, the parameters are not limited to the ones used in the aforementioned embodiment (author, content, date). With smart phones growing more powerful, it is also possible to determine the similarity between data using a wide variety of different parameters, such as GPS location, IP address, URL links, photos, audios and videos, etc. The above embodiment combines data by a same author posted on different networks. However, this is not limited thereto. It is also possible to aggregate the data according to other parameters. For example, data containing similar contents such as keywords or shared web links can be combined to show how many of your friends are following a same popular event, news article, etc. When replying, it is possible to reply to all of the friends who share an interest in the topic. Furthermore, aggregation by location can allow users to filter out data from friends within a geographical proximity, and reply to these nearby friends.

In the prior art, someone who subscribes to a user's social status may receive redundant or identical data originating from different network accounts of the user. This may cause information overload by requiring users to sift through and process a lot of redundant network data, which is also very time-consuming. In comparison, the present invention allows similar social data to be combined before being presented to the user. Thus, the user would be able to process and reply to the network data with much greater efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of combining network data for a mobile device, comprising:
connecting to a plurality of networks;
receiving a plurality of data from the plurality of networks;
obtaining a plurality of parameters from each of the plurality of data;
comparing the plurality of parameters of each of the plurality of data, to obtain a plurality of similar data;
combining the plurality of similar data into at least one combined data; and
displaying the at least one combined data.

2. The method of claim 1, wherein the plurality of parameters are one or more of author ID, data content, image content obtained from each of the plurality of data, video content obtained from each of the plurality of data, data generating time, data generating location, network type, and internet protocol (IP) address.

3. The method of claim 1, wherein the step of comparing the plurality of parameters of each of the plurality of data to obtain the plurality of similar data comprises determining a first data and a second data within the plurality of data are similar data if the first data and the second data have at least one identical matching parameter.

4. The method of claim 1, wherein the step of comparing the plurality of parameters of each of the plurality of data to obtain the plurality of similar data comprises requesting a user to manually determine whether a first data and a second data within the plurality of data are similar data if the first data and the second data have at least one similar but not identical matching parameter.

5. The method of claim 1, further comprising displaying each of a plurality of dissimilar data within the plurality of data excluding the plurality of similar data.

6. The method of claim 1, wherein the plurality of networks comprise one or more of public network, private network and social network.

7. A method of replying to network data for a mobile device, comprising:
obtaining a combined data corresponding to a plurality of similar data from a plurality of networks;
obtaining a reply data corresponding to the combined data from a user; and
replying to at least one of the plurality of similar data with the reply data.

8. The method of claim 7, wherein the step of replying to at least one of the plurality of similar data with the reply data comprises requesting a user to manually determine whether to reply to all of the plurality of similar data with the reply data.

9. The method of claim 7, wherein the plurality of similar data have at least one similar parameter, selected from at least one of author ID, data content, image content obtained from each of the plurality of similar data, video content obtained from each of the plurality of similar data, data generating time, data generating location, network type, and internet protocol (IP) address.

10. The method of claim 7, wherein the plurality of networks comprise one or more of public network, private network and social network.

11. A mobile device for combining network data, comprising:
a communication interfacing unit, for connecting to a plurality of networks;
a processing means; and
a storage unit, for storing a program code to indicate the processing means to perform the following steps:
receive a plurality of data from the plurality of networks;
obtain a plurality of parameters from each of the plurality of data;
compare the plurality of parameters of each of the plurality of data, to obtain a plurality of similar data;
combine the plurality of similar data into at least one combined data; and
display the at least one combined data.

12. The mobile device of claim 11, wherein the plurality of parameters are one or more of author ID, data content, image content obtained from each of the plurality of data, video content obtained from each of the plurality of data, data generating time, data generating location, network type, and internet protocol (IP) address.

13. The mobile device of claim 11, wherein the processing means determines a first data and a second data within the plurality of data are similar data if the first data and the second data have at least one identical matching parameter.

14. The mobile device of claim 11, wherein the processing means requests a user to manually determine whether a first data and a second data within the plurality of data are similar data if the first data and the second data have at least one similar but not identical matching parameter.

15. The mobile device of claim 11, wherein the program code further indicates the processing means display each of a plurality of dissimilar data within the plurality of data excluding the plurality of similar data.

16. The mobile device of claim 11, wherein the plurality of networks comprise one or more of public network, private network and social network.

17. A mobile device for replying to network data, comprising:
a communication interfacing unit, for connecting to a plurality of networks;
a processing means; and
a storage unit, for storing a program code to indicate the processing means to perform the following steps:
obtain a combined data corresponding to a plurality of similar data from the plurality of networks;
obtain a reply data corresponding to the combined data from a user; and
reply to at least one of the plurality of similar data with the reply data.

18. The mobile device of claim 17, wherein the processing means requests a user to manually determine whether to reply to all of the plurality of similar data with the reply data.

19. The mobile device of claim 17, wherein the plurality of similar data have at least one similar parameter, selected from at least one of author ID, data content, image content obtained from each of the plurality of similar data, video content obtained from each of the plurality of similar data, data generating time, data generating location, network type, and internet protocol (IP) address.

20. The mobile device of claim 17, wherein the plurality of networks comprise one or more of public network, private network and social network.

21. A machine readable storage medium storing executable program instructions which when executed cause a data processing system to perform a method, comprising:
connecting to a plurality of networks;
receiving a plurality of data from the plurality of networks;
obtaining a plurality of parameters from each of the plurality of data;
comparing the plurality of parameters of each of the plurality of data, to obtain a plurality of similar data;
combining the plurality of similar data into at least one combined data; and
displaying the at least one combined data.

22. The medium as in claim 21, wherein the plurality of parameters are one or more of author ID, data content, image content obtained from each of the plurality of data, video content obtained from each of the plurality of data, data generating time, data generating location, network type, and internet protocol (IP) address.

23. The medium as in claim 21, wherein the step of comparing the plurality of parameters of each of the plurality of data to obtain the plurality of similar data comprises determining a first data and a second data within the plurality of data are similar data if the first data and the second data have at least one identical matching parameter.

24. The medium as in claim 21, wherein the step of comparing the plurality of parameters of each of the plurality of data to obtain the plurality of similar data comprises requesting a user to manually determine whether a first data and a second data within the plurality of data are similar data if the first data and the second data have at least one similar but not identical matching parameter.

25. The medium as in claim 21, further comprising
displaying each of a plurality of dissimilar data within the plurality of data excluding the plurality of similar data.

26. The medium as in claim 21, wherein the plurality of networks comprise one or more of public network, private network and social network.

27. A machine readable storage medium storing executable program instructions which when executed cause a data processing system to perform a method, comprising:
obtaining a combined data corresponding to a plurality of similar data from a plurality of networks;
obtaining a reply data corresponding to the combined data from a user; and
replying to at least one of the plurality of similar data with the reply data.

28. The medium as in claim 27, wherein the step of replying to at least one of the plurality of similar data with the reply data comprises requesting a user to manually determine whether to reply to all of the plurality of similar data with the reply data.

29. The medium as in claim 27, wherein the plurality of similar data have at least one similar parameter, selected from at least one of author ID, data content, image content obtained from each of the plurality of similar data, video content obtained from each of the plurality of similar data, data generating time, data generating location, network type, and internet protocol (IP) address.

30. The medium as in claim 27, wherein the plurality of networks comprise one or more of public network, private network and social network.
